(19) United States
(12) Patent Application Publication
(10) Pub. No.: US 2026/0339773 A1
(43) Pub. Date: Oct. 29, 2026

(54) ARTIFICIAL INTELLIGENCE (AI) ASSISTANT FOR ENDPOINT NETWORK ACCESS TROUBLESHOOTING

(71) Applicant: Cisco Technology, Inc., San Jose, CA (US)

(72) Inventors: Danxiang Li, Arlington, MA (US); Zhouyu Lin, Arlington, MA (US); Vincent E. Parla, North Hampton, NH (US); Scott Allen Goldman, Sharon, MA (US)

(21) Appl. No.: 19/192,079

(22) Filed: Apr. 28, 2025

(51) Int. Cl. G06F 11/07

(52) U.S. Cl. CPC G06F 11/0793; G06F 11/0748

(57) ABSTRACT

Techniques for observing network configuration(s) and/or pattern(s) for utilizing artificial intelligence (AI) assistant(s) to troubleshoot network access issue(s) on endpoint device(s). An AI assistant executing locally on an endpoint device may be configured to troubleshoot issues (e.g., hardware and/or software based issues) that a user may encounter. The AI assistant may leverage one or more large language model(s) (LLM(s)) and/or an event journal comprising log data indicative of user interactions and/or events occurring on the endpoint device to build an understanding of the issue. User's may converse with the AI assistant and that conversation may be utilized by the AI assistant as a query to determine a subset of events corresponding to a given issue and utilize the subset of events to generate a recommendation including instructions to resolve the issue, generate data representing a support ticket describing the issue, and/or execute instructions configured to resolve the issue.

### TECHNICAL FIELD

The present disclosure relates generally to, among other things, techniques for utilizing artificial intelligence (AI) assistant(s) to troubleshoot network access issue(s) on endpoint device(s).

### BACKGROUND

Computing resource networks provide users with access to computing resources and/or network infrastructure to fulfill an entity's (e.g., a single user, a corporation, an enterprise, etc.) computing resource needs without having to invest in and maintain computing infrastructure required to implement the services. These service providers often maintain networks of data centers which house servers, routers, and other devices that provide computing resources to users associated with the entity such as compute resources, networking resources, storage resources, database resources, application resources, security resources, and so forth. The solutions offered by service providers may include a wide range of services that may be fine-tuned to meet the entity's needs, and users associated with the entity may leverage these computing resources to host their workloads. However, when a user cannot access a resource (e.g., a corporate network resource) from their endpoint device due to issues with network access software (e.g., virtual private network(s) (VPN(s)), zero trust access, etc.) that operates silently in the background, the experience for the user can become quite frustrating. That is, the user may not be able to load a webpage, or a corporate application and the user is left not knowing what the issue is or how to resolve it. In most cases, the only obvious remediation step is to file a ticket with the internet technology (IT) department, starting a lengthy troubleshooting process that involves an IT administrator asking questions and manually analyzing troves of endpoint logs. Moreover, the issue occurring on the endpoint device may prevent the endpoint device from submitting a ticket with the IT department, leading to more delays in resolving the issue. Thus, there is a need for a better means of troubleshooting of issues occurring on an endpoint device.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example environment for invoking an artificial intelligence (AI) assistant to resolve an issue associated with an endpoint device according to the techniques described herein.

FIG. 2 illustrates a system-architecture diagram of an example endpoint device and flow for invoking an AI assistant to resolve an issue associated with the endpoint device, according to the techniques described herein.

FIG. 3A illustrates a diagram of example user interface(s) that may be displayed in association with the AI assistant, as described herein.

FIG. 3B illustrates a diagram of another example user interface(s) that may be displayed in association with the AI assistant, as described herein.

FIG. 3C illustrates a diagram of another example user interface(s) that may be displayed in association with the AI assistant, as described herein.

FIG. 4 illustrates a flow diagram of an example method for invoking an AI assistant to resolve an issue associated with the endpoint device according to the techniques described herein.

FIG. 5 illustrates a flow diagram of an example method for invoking an AI assistant to resolve an issue associated with establishing a connection between the endpoint device and a resource according to the techniques described herein.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes method(s) for utilizing artificial intelligence (AI) assistant(s) to troubleshoot network access issue(s) on endpoint device(s). The method may include storing, by an artificial intelligence (AI) software assistant executing on an endpoint device, an event log comprised of log data generated by the endpoint device, the log data indicative of events that have occurred on the endpoint device. Additionally, or alternatively, the method may include receiving, at the AI software assistant, first data describing an issue associated with establishing a connection between the endpoint device and a resource. Additionally, or alternatively, the method may include determining, based at least in part on the AI software assistant querying a large language model (LLM) utilizing the first data, a type of the issue associated with establishing the connection. Additionally, or alternatively, the method may include identifying the resource that the endpoint device is having the issue establishing the connection to. Additionally, or alternatively, the method may include determining, based at least in part on the AI software assistant querying the event log for events associated with the resource, a subset of the events corresponding to the issue associated with establishing the connection between the endpoint device and the resource. Additionally, or alternatively, the method may include generating, based at least in part on the subset of the events, second data including first text representing a first recommendation to be presented on the endpoint device, the first recommendation comprising first instructions to be performed by a user of the endpoint device to resolve the issue associated with establishing the connection. Additionally, or alternatively, the method may include generating, based at least in part on the subset of the events, third data including second text representing a support ticket to be sent to a computing device, the support ticket comprising a description of the issue associated with establishing the connection and indications representative of individual ones of the subset of the events. Additionally, or alternatively, the method may include executing, by the AI software assistant and based at least in part on the subset of the events, fourth data representing second instructions to resolve the issue associated with establishing the connection, the fourth data being retrieved by the AI software assistant from a database based at least in part on the subset of the events.

Additionally, or alternatively, the method may include storing, by an artificial intelligence (AI) software assistant executing on an endpoint device, an event log comprised of log data generated by the endpoint device, the log data indicative of events that have occurred on the endpoint device. Additionally, or alternatively, the method may include receiving, at the AI software assistant, first data describing an issue associated with the endpoint device. Additionally, or alternatively, the method may include determining, based at least in part on the AI software assistant querying a large language model (LLM) utilizing the first data, a type of the issue associated with the endpoint device. Additionally, or alternatively, the method may include querying, by the AI assistant and based at least in part on the type of the issue, the event log to determine a subset of the events corresponding to the issue associated with the endpoint device. Additionally, or alternatively, the method may include generating, based at least in part on the subset of the events, second data including first text representing a first recommendation comprising first instructions to be performed by a user of the endpoint device to resolve the issue. Additionally, or alternatively, the method may include generating, based at least in part on the subset of the events, third data to be sent to a computing device, the third data including second text representing at least one of a description of the issue associated with the endpoint device or indications representative of individual ones of the subset of the events. Additionally, or alternatively, the method may include executing, by the AI software assistant and based at least in part on the subset of events, fourth data representing second instructions to resolve the issue associated with the endpoint device, the fourth data being retrieved by the AI software assistant from a database based at least in part on the subset of the events.

The techniques described herein may be performed as a method and/or by a system having non-transitory computer-readable media storing computer-executable instructions that, when executed by one or more processors, cause the system to perform the techniques described above and herein.

### EXAMPLE EMBODIMENTS

As previously described, when a user cannot access a resource (e.g., a corporate network resource) from their endpoint device due to issues with network access software (e.g., virtual private network(s) (VPN(s)), zero trust access, etc.) that operates silently in the background, the experience for the user can become quite frustrating. That is, the user may not be able to load a webpage, or a corporate application and the user is left not knowing what the issue is or how to resolve it. In most cases, the only obvious remediation step is to file a ticket with the internet technology (IT) department, starting a lengthy troubleshooting process that involves an IT administrator asking questions and manually analyzing troves of endpoint logs. Moreover, the issue occurring on the endpoint device may prevent the endpoint device from submitting a ticket with the IT department, leading to more delays in resolving the issue. Thus, there is a need for a better means of troubleshooting of issues occurring on an endpoint device.

This application describes techniques for utilizing artificial intelligence (AI) assistant(s) to troubleshoot network access issue(s) on endpoint device(s). In some examples, an AI assistant executing on a user's endpoint device may be configured to troubleshoot network access issues (or other issues associated with one or more hardware and/or software components of the endpoint device) that a user may encounter by leveraging one or more large language model(s) and an event journal comprising log data indicative of user interactions and/or events occurring on the endpoint device. That is, an AI assistant may obtain log data generated by the endpoint device and store the log data in an event journal. The AI assistant may be configured to converse with the user and that conversation may be utilized by the AI assistant as a query to determine a subset of events corresponding to a given issue and utilize the subset of events to generate a recommendation including instructions to resolve the issue, generate data representing a support ticket describing the issue, and/or execute instructions configured to resolve the issue. In some examples, the events may be collected from various sources. For example, some events may be standard operating events that are processed for machine parsing. Additionally, or alternatively, other events may be specifically outputted from software (e.g., a network access software) executing on the endpoint device for the purpose of troubleshooting issues with the AI assistant. These events may collectively represent facts about what has recently happened on the endpoint device. In some examples, the event journal may serve as a knowledge base for an LLM-based AI assistant that is configured to converse with the user to understand the user and guide them onto next steps. That is, the AI assistant may be configured to monitor and/or analyze a digital experience of the user interacting with their device and/or other digital services (e.g., websites, applications, etc.) to gain understanding and/or optimize performance of the digital experience by troubleshooting issues that arise.

Take, for example, a user experiencing an issue with their device (e.g., an endpoint device). The user may interact with an AI assistant installed on the device to describe the issue to the AI assistant. Additionally, or alternatively, an AI assistant may be configured to constantly analyze log data collected on the user's endpoint device, such that when the user invokes the AI assistant, the AI assistant may proactively propose a list of potential issues identified based on the log analysis and ask the user if they need help with any of the listed issues. In some examples, the issue may be any issue associated with software and/or hardware of the device that a user may encounter during use of the device. For example, the issue may be that the endpoint device is having trouble connecting to a resource. In some examples, the issue may stem from software of the endpoint device (e.g., zero-trust network access (ZTNA) software, virtual private network (VPN) software, the endpoint device not being connected to a wireless network, etc.) that is causing the issue. Additionally, or alternatively, the issue may stem from hardware of the endpoint device (e.g., a wireless card has failed, ethernet is unplugged, etc.).

In any event, the user may describe the issue (to the best of their ability) to the AI assistant. That is, the user may provide input (e.g., text input, voice input, touch input, and/or any other form of input) to the endpoint device (via keyboard, microphone, touchscreen, mouse, and/or any other peripheral input device) to describe the issue in natural language. For example, the user may ask the AI assistant “Why can't I access www. resource. com?” In some examples, the AI assistant may be configured to classify a type of the issue being described by the user prior to responding and/or reacting to the user. For example, the AI assistant may leverage one or more LLMs to query for the intent of user's query (or issue), and the AI assistant may classify the type of the issue. In some examples, the issue may be any kind of software and/or hardware related issue occurring on a user endpoint device (e.g., a laptop, desktop, a mobile phone, etc.), such as, for example, an issue establishing an internet connection, an issue establishing a connection to a resource, an issue with the quality of a connection (e.g., internet connection, connection to a resource, etc.), a policy issue, and/or the like. For example, as described above, the user may be having an issue accessing a resource (e.g., a website, application, etc.). In some examples, the AI assistant may query the LLM to extract the resource that the user is having the issue with. Additionally, or alternatively, the AI assistant may be configured to ask the user (e.g., via text, audio, and/or any other means of natural language communication) to confirm that the resource extracted is correct. Additionally, or alternatively, the AI assistant may be configured to ask the user to confirm the time of access (e.g., the time that the user encountered the issue accessing the resource).

In some examples, the AI assistant may be configured look for relevant events related to the user's issue. For example, the AI assistant may access the event journal to identify events that are related to the issue described by the user and/or confirmed by the AI assistant. In some examples, these events may be utilized by the AI assistant to continue to build an understanding of what the user did (e.g., actions the user has taken on the endpoint device) and/or what has happened at the network level. In some examples, the AI assistant may be configured to ask the user to confirm the AI assistant's understanding of what has happened until the AI assistant has aligned with what the user has experienced. In some examples, the user may provide a confirmation, a rejection, and/or any other natural language input as a response. For example, the AI assistant may ask the user to confirm that they were having an issue with “www.someresource.com” at a first time (e.g., 12:00 PM). In such an example, the user may correct the AI assistant and indicate that the user was having the issue with “www. resource. com” at the first time, and the AI assistant may ask the user to confirm the understanding of the issue any number of times prior to proceeding.

As described herein, the AI assistant may be configured to respond in various ways. For example, the AI assistant may be configured to generate a recommendation including instructions to resolve the issue. Additionally, or alternatively, the AI assistant may be configured to generate data representing a support ticket describing the issue. Additionally, or alternatively, the AI assistant may be configured to execute instructions configured to resolve the issue.

As previously described, the AI assistant may use generative AI text generation to recommend next steps to the user. In some examples, the AI assistant may determine that there is not enough information in the event journal to provide a recommendation to the user. For example, the AI assistant may determine that the subset of events identified does not satisfy a threshold amount of information needed to generate a recommendation. In examples where the AI assistant determines that there is not enough information, the AI assistant may be configured to provide instructions to the user regarding how to enable additional logging. In some examples, the AI assistant may be integrated with software on the endpoint device (e.g., integrated into a network access software) and the AI assistant may be configured to automatically enable verbose logging in that software it is integrated with. Additionally, or alternatively, the AI assistant may be configured to automatically trigger diagnostic probes, such as, for example, traceroute, to the resource in question to collect additional data about the issue. In any event, while the AI assistant is gathering more information (e.g., enabling verbose logging, triggering probes, and/or instructing the user to enable additional logging), the AI assistant may be configured to preserve the context of the user's query regarding the issue in the chat session while the user reproduces the issue with the additional logging enabled.

Once the AI assistant has identified enough information in the event journal to generate a recommendation for the user, the AI assistant may generate utilize generative AI text generation to recommend next steps to resolve the issue based on a subset of events identified in the event journal that are relevant to the issue. In some examples, the AI assistant may output the recommendations in the form of text data, audio data, and/or any other form of data that represents natural language communication. Additionally, or alternatively, any number of recommendations may be generated by the AI assistant and/or output in any order. The AI assistant may be configured to generate additional recommendations based on responses from the user with respect to prior recommendations generated by the AI assistant.

In some examples, the AI assistant may determine that the issue is user remediable. For example, the issue may be related to updating software (e.g., updating a network access software), which is an action that may be performed by the user. The AI assistant may then generate the recommendations to instruct the user on how to resolve the issue that is user remediable. For example, the AI assistant may generate recommendations for the user including step-by-step instructions to update the software. Additionally, or alternatively, the issue may be policy related (e.g., access denied due to lack of permission), which may be out of the user's control. As such, the AI assistant may be configured to generate recommendation(s) for the user including an explanation that the resource is unable to be accessed because the user's network policy (e.g., an enterprise related policy) does not allow the user to access the resource.

Additionally, or alternatively, the issue may require intervention by an IT administrator associated with the endpoint device (e.g., an IT administrator of an enterprise associated with the endpoint device). In some examples, the AI assistant may be configured to generate and/or file an IT support ticket on behalf of the user. For example, the AI assistant may be configured to generate an IT support ticket having a title and a summary relevant to the issue based on the conversation the AI assistant had with the user. In some examples, the AI assistant may be configured to attach a raw transcript of the conversation with the user to the IT support ticket. Additionally, or alternatively, the AI assistant may be configured to attach any relevant events from the journal and/or any other artifacts of its analysis of the issue. Additionally, or alternatively, the AI assistant may be configured to highlight the time of occurrence of the issue and/or any other anomalous events on the IT support ticket. Additionally, or alternatively, the AI assistant may be configured to include any network access policy related details in the IT support ticket.

As described herein, the AI assistant may be configured to process network access policies to determine if a user is configured to access the resource the user is having the issue with. For example, the AI assistant may be configured to leverage virtual private network (VPN) routing tables and/or zero trust access steering rules indicated by network access policies to determine whether a given user is configured to access a given resource.

In some examples, the AI assistant may be supplemented with an additional mechanism to execute instructions configured to resolve an issue that may be known, commonly occurring, and/or previously resolved. For example, the IT administrator may define fingerprints of common issues that users may encounter along with instructions on how to remediate said issue. The IT administrator may store the fingerprints in a centralized location that is accessible by various AI assistants executing on various endpoint devices remote from one another. That is, an AI assistant executing on an endpoint device may look for matching fingerprints in the event journal, and if identified, may obtain the instructions from the centralized database and execute the instructions to resolve the issue. In some examples, the fingerprints may be defined using a domain specific language (DSL). Additionally, or alternatively, a centralized AI assistant may be configured to monitor operation of additional AI assistants executing locally on remote endpoint devices, and the centralized AI assistant may be configured to learn new issues that are easily remediable and may generate new fingerprints with instructions to resolve these new issues.

The AI assistant(s) described herein may be configured to leverage cloud-based generate AI and/or LLM(s). Additionally, or alternatively, the AI assistant(s) described herein may be configured to use local models enhanced with localized framework of the endpoint device.

As described herein, a computing-based, network-based, cloud-based service, network device, switch, resource, and/or server can generally include any type of resources implemented by virtualization techniques, such as containers, virtual machines, virtual storage, and so forth. Further, although the techniques described as being implemented in distributed networks, such as, data centers, colocation networks, and/or a cloud computing networks, the techniques are generally applicable for any network of devices managed by any entity where virtual resources are provisioned. In some instances, the techniques may be performed by a schedulers or orchestrator, and in other examples, various components may be used in a system to perform the techniques described herein. The devices and components by which the techniques are performed herein are a matter of implementation, and the techniques described are not limited to any specific architecture or implementation.

The techniques described herein provide various improvements and efficiencies with respect to resolving issues occurring on endpoint devices using generative AI. For instance, the techniques described herein include executing an AI assistant that is configured to leverage log data stored in an event journal indicative of events occurring on an endpoint device. By executing the AI assistant on the endpoint device and utilizing the event journal, the AI assistant may identify events relevant to a given issue that a user is experiencing on their device to gain an understanding of the issue. This increases the accuracy of recommendations for resolving issues that are generated by the AI assistant. Further, by utilizing an AI assistant to troubleshoot issues occurring on the endpoint device, issues may be resolved faster than traditional methods that include submitting an IT support ticket. That is, by executing the AI assistant on the endpoint device, a user can access the AI assistant without an internet connection, allowing for even recommendations resolving internet connection issues. Additionally, the AI assistant may be configured to identify a fingerprint of a common problem and pull instructions from a database that may be executed by the AI assistant to resolve the issue. As a result, networked environments, such as, for example, enterprise networks may be more stable as common issues may be resolved in a quicker manner without human intervention and/or issues may be resolved by the user being instructed by the AI assistant. Further, the AI assistant may instruct the user how to enable additional logging and/or may trigger diagnostic probes to collect additional data about the issue, resulting in greater accuracy when recommending remediation instructions. The techniques described herein also increase network security as the AI assistant may execute locally on a user endpoint device and a user does not have to provide any confidential information over the internet to receive recommendations from the AI assistant.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

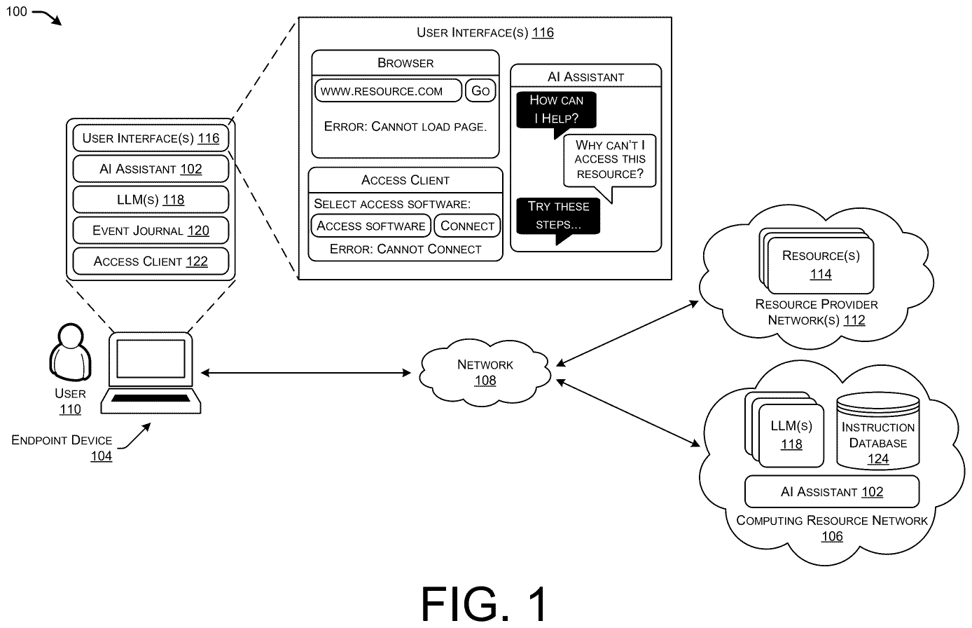

FIG. 1 illustrates a system-architecture diagram of an example environment 100 for invoking an artificial intelligence (AI) assistant 102 to resolve an issue associated with an endpoint device 104 according to the techniques described herein. In some examples, the AI assistant 102 may be configured as a local AI assistant executing on the endpoint device 104. Additionally, or alternatively, the AI assistant 102 may be configured as a cloud-based AI assistant executing in a computing resource network 106 that may be connected to and/or accessible by the endpoint device 104 via one or more network(s) 108. The environment 100 may include an endpoint device 104 operated by a user 110, one or more computing resource network(s) 106, and/or one or more resource provider network(s) 112. In some examples, the computing resource network(s) 106 and/or the resource provider network(s) 112 may be accessible by the endpoint device 104 via one or more network(s) 108.

Generally, the computing resource network(s) 106 and/or the resource provider network(s) 112 may include devices that are housed or located in one or more data centers that may be located at different physical locations. For instance, the computing resource network 106 may be supported by networks of devices in a public cloud computing platform, a private/enterprise computing platform, and/or any combination thereof. The one or more data centers may be physical facilities or buildings located across geographic areas that are designated to store networked devices that are part of the computing resource network(s) 106 and/or the resource provider network(s) 112. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the computing resource network(s) 106 and/or the resource provider network(s) 112 may not be located in explicitly defined data centers and, rather, may be located in other locations or buildings.

Generally, the endpoint device 104 may comprise user interface(s) 116, an AI assistant 102, LLM(s) 118, an event journal 120, and/or an access client 122. In some examples, an AI assistant 102 executing on a user's 110 endpoint device 104 may be configured to troubleshoot network access issues (or other issues associated with one or more hardware and/or software components of the endpoint device 104) occurring with respect to an access client 122 on the endpoint device 104. In some examples, the access client 122 may be required to be utilized by a user 110 on the endpoint device 104 to access a resource 114 offered by resource provider network(s) 112. For example, the access client 122 may be configured as a VPN and/or a zero-trust access client configured to allow a user to access enterprise resources 114 hosted in an enterprise network (e.g., resource provider network(s) 112). In some examples, the AI assistant 102 may be integrated into the access client 122, such that the AI assistant 102 may be invoked via the access client 122.

The computing resource network 106 may be configured to host an AI assistant 102 that is cloud-based that may be utilized to execute the techniques described herein with respect to the AI assistant 102 executing locally on the endpoint device 104. That is, the computing resource network 106 may include an AI assistant 102 and/or one or more LLM(s) 118. In some examples, an AI assistant 102 executing locally on an endpoint device 104 may optionally utilize one or more cloud-based LLM(s) 118 provided by the computing resource network 106. Additionally, or alternatively, the computing resource network 106 may include an instruction database 124 storing instructions configured to resolve issues that may be known, commonly occurring, and/or previously resolved. For example, an IT administrator (e.g., an IT administrator of an enterprise network) may define fingerprints of common issues that users 110 may encounter along with instructions on how to remediate said issue. The IT administrator may store the fingerprints in the instruction database 124, configured as centralized location that is accessible by AI assistants 102 executing locally on endpoint devices 104 remote from one another. That is, an AI assistant 102 executing on an endpoint device 104 may look for matching fingerprints in the event journal 120, and if identified, may obtain the instructions from the instruction database 124 and execute the instructions to resolve the issue. In some examples, the fingerprints may be defined using a domain specific language (DSL). Additionally, or alternatively, a centralized AI assistant (e.g., the AI assistant 102 of the computing resource network 106) may be configured to monitor operation of additional AI assistants (e.g., the AI assistant 102 executing on the endpoint device 104) executing locally on remote devices, and the centralized AI assistant may be configured to learn new issues that are easily remediable and may generate new fingerprints with instructions to resolve these new issues.

The AI assistant 102 may assist the user 110 with an issue that may occur by leveraging LLM(s) 118 and an event journal 120 comprising log data indicative of user 110 interactions and/or events occurring on the endpoint device 104. That is, an AI assistant 102 may obtain log data generated by the endpoint device 104 and store the log data in an event journal 120. The AI assistant 102 may be configured to converse with the user 110 and that conversation may be utilized by the AI assistant 102 as a query to the LLM(s) 118 to determine a subset of events corresponding to a given issue and utilize the subset of events to generate a recommendation including instructions to resolve the issue, generate data representing a support ticket describing the issue, and/or execute instructions configured to resolve the issue.

In some examples, the events may be collected from various sources. For example, some events may be standard operating events on the endpoint device 104 that are processed for machine parsing. Additionally, or alternatively, other events may be specifically outputted from software (e.g., a network access software) executing on the endpoint device 104 for the purpose of troubleshooting issues with the AI assistant 102. These events may collectively represent facts about what has recently happened on the endpoint device 104. In some examples, the event journal 120 may serve as a knowledge base for the AI assistant 102 that is configured to converse with the user to understand the user and guide them onto next steps. That is, the AI assistant 102 may be configured to monitor and/or analyze a digital experience of the user 110 interacting with their endpoint device 104 and/or resources 114 (e.g., websites, applications, etc.) to gain understanding and/or optimize performance of the digital experience by troubleshooting issues that arise.

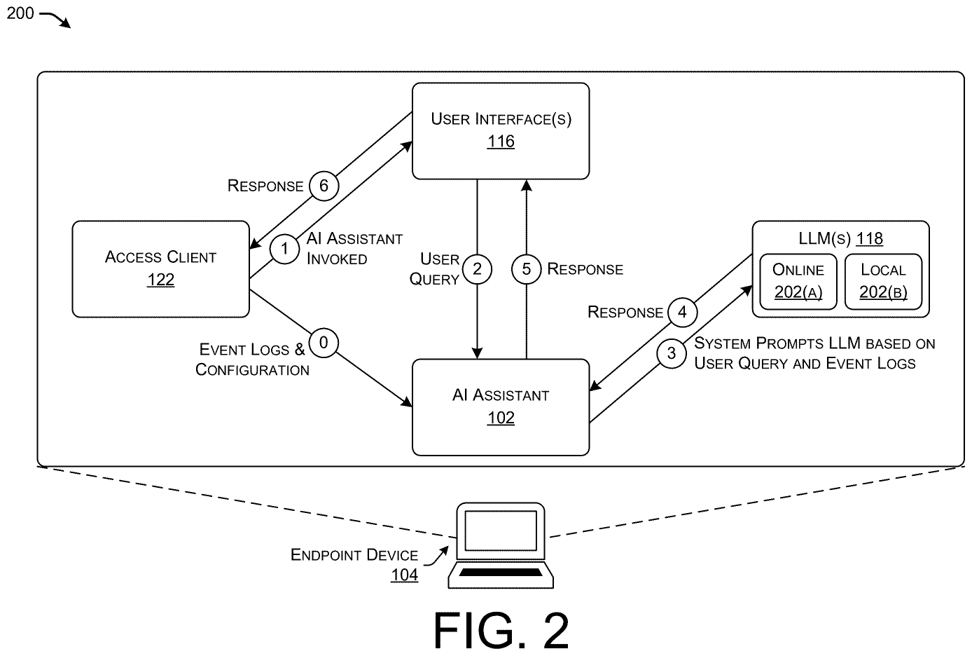

As described in more detail below with respect to FIG. 2, the AI assistant 102 may be configured to respond in various ways. For example, the AI assistant 102 may be configured to generate a recommendation including instructions to resolve the issue. Additionally, or alternatively, the AI assistant 102 may be configured to generate data representing a support ticket describing the issue. Additionally, or alternatively, the AI assistant 102 may be configured to execute instructions configured to resolve the issue. The AI assistant(s) 102 described herein may be configured to leverage cloud-based generate AI and/or LLM(s). Additionally, or alternatively, the AI assistant(s) 102 described herein may be configured to use local models enhanced with localized framework of the endpoint device.

An example flow of invoking an AI assistant 102 executing on an endpoint device 104 to resolve an issue associated with the endpoint device 104 is described in more detail below with respect to FIG. 2.

FIGS. 2, 4, and 5 illustrate flow diagrams of example methods (or processes/flows) 200, 400, and 500 that illustrate aspects of the functions performed at least partly by the endpoint device 104 and/or the computing resource network 106, as described with respect to FIG. 1. The logical operations described herein with respect to FIGS. 2, 4, and 5 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 2, 4, and 5, and as described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 2 illustrates a system-architecture diagram 200 of an example endpoint device 104 and flow for invoking an AI assistant 102 to resolve an issue associated with the endpoint device 104, according to the techniques described herein. While not illustrated in FIG. 2, the event journal 120 as described with respect to FIG. 1 may be represented by the AI assistant 102 in FIG. 2.

At “0,” the AI assistant 102 may be configured to collect event logs and/or configuration data associated with the endpoint device 104 and/or the access client 122. That is, the AI assistant 102 may collect event logs indicative of events occurring with respect to the access client 122 (e.g., log data generated by the access client 122) and/or configuration data indicative of a configuration of the access client 122 (e.g., network access policies associated with a user of the endpoint device 104 and/or other configuration data associated with the access client 122).

In some examples, step “0” may continuously execute in the background to collect the most recent event logs. That is, step “0” may be configured to execute any time log data is generated by the endpoint device 104 and/or the access client 122.

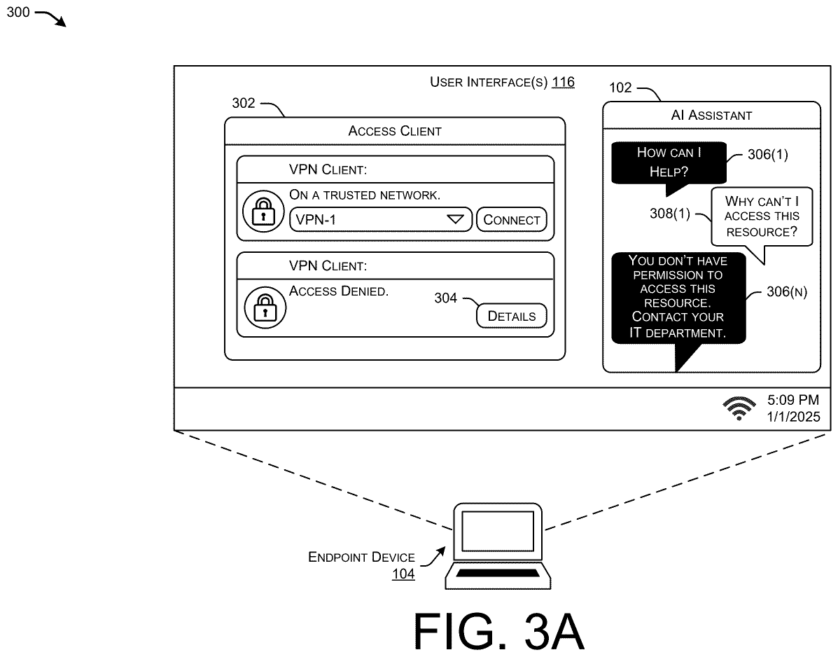

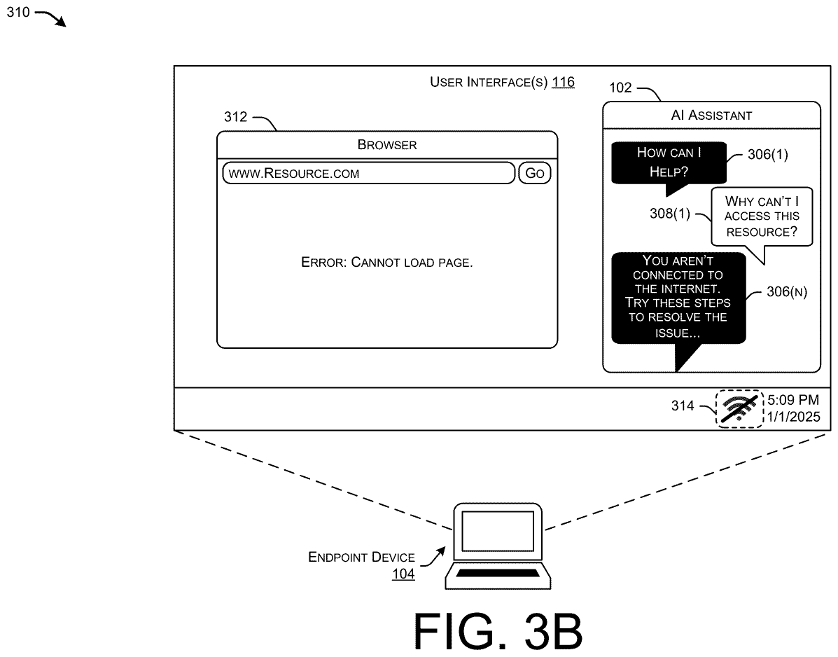

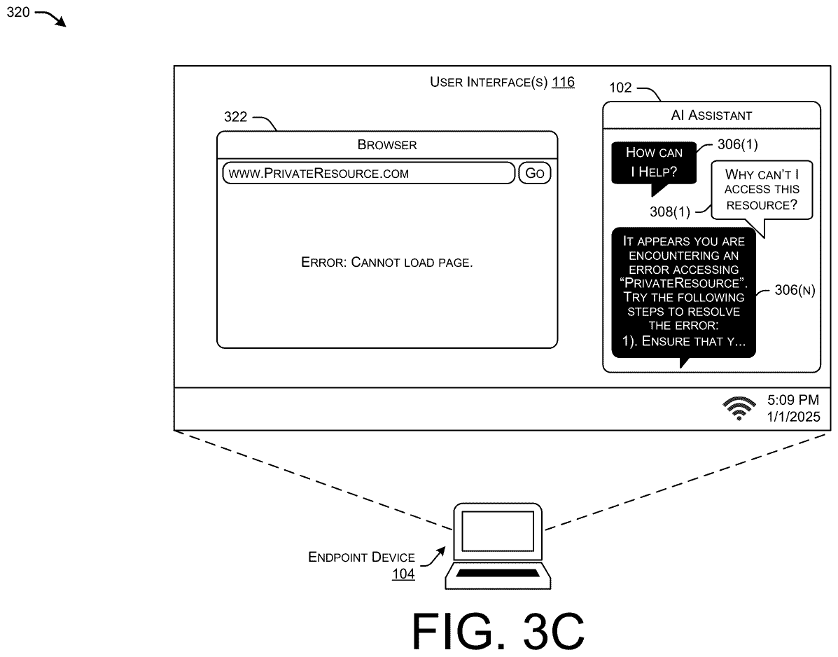

At “1,” the AI assistant 102 may be invoked. In some examples, the AI assistant 102 may be invoked by a user interacting with the endpoint device 104 and/or software thereon (e.g., standalone AI assistant software and/or software integrated with the AI assistant 102, such as, for example, the access client 122). Additionally, or alternatively, the AI assistant 102 may be invoked by interacting with a user interface 116 of the endpoint device 104, as described in more detail with respect to FIGS. 3A-3C.

Generally, the AI assistant 102 may be invoked when a user encounters an issue. Take, for example, a user experiencing an issue with the endpoint device 104. The user may invoke an AI assistant 102 to describe the issue to the AI assistant 102. In some examples, the issue may be any issue associated with software and/or hardware of the endpoint device 104 that a user may encounter during use of the endpoint device 104. For example, the issue may be that the endpoint device 104 is having trouble connecting to a resource (e.g., the resource 114 described with respect to FIG. 1). In some examples, the issue may stem from software of the endpoint device 104 (e.g., the access client 122) that is causing the issue. Additionally, or alternatively, the issue may stem from hardware of the endpoint device (e.g., a wireless card has failed, ethernet is unplugged, etc.).

At “2,” the user may describe the issue (to the best of their ability) to the AI assistant 102. That is, the user may provide input (e.g., text input, voice input, touch input, and/or any other form of input) to the endpoint device 104 (via keyboard, microphone, touchscreen, mouse, and/or any other peripheral input device) to describe the issue in natural language. For example, the user may ask the AI assistant 102 “Why can't I access www.resource.com?” In some examples, the AI assistant 102 may be configured to classify a type of the issue being described by the user prior to responding and/or reacting to the user.

For example, at “3,” the AI assistant 102 may leverage LLM(s) 118 to query for the intent of user's query (or issue), and the AI assistant 102 may classify the type of the issue. In some examples, the LLM(s) 118 may be configured as online LLM(s) 202(a) and/or local LLM(s) 202(b). Additionally, or alternatively, the issue may be any kind of software and/or hardware related issue occurring on a user endpoint device (e.g., a laptop, desktop, a mobile phone, etc.), such as, for example, an issue establishing an internet connection, an issue establishing a connection to a resource, an issue with the quality of a connection (e.g., internet connection, connection to a resource, etc.), a policy issue, and/or the like.

At “4,” the AI assistant 102 may receive a response from the LLM(s). For example, as described above, the user may be having an issue accessing a resource (e.g., a website, application, etc.). In some examples, the AI assistant 102 may query the LLM(s) 118 to extract the resource that the user is having the issue with. Additionally, or alternatively, the AI assistant 102 may be configured to ask the user (e.g., via text, audio, and/or any other means of natural language communication) to confirm that the resource extracted is correct. Additionally, or alternatively, the AI assistant 102 may be configured to ask the user to confirm the time of access (e.g., the time that the user encountered the issue accessing the resource).

In some examples, the AI assistant 102 may be configured look for relevant events related to the user's issue. For example, the AI assistant 102 may access the event journal (e.g., the event journal 120, as described with respect to FIG. 1) to identify events that are related to the issue described by the user and/or confirmed by the AI assistant 102. In some examples, these events may be utilized by the AI assistant 102 to continue to build an understanding of what the user did (e.g., actions the user has taken on the endpoint device 104) and/or what has happened at the network level.

At “5,” the AI assistant may generate one or more responses to display on the user interface 116 to converse with the user. As described herein, the AI assistant may be configured to respond in various ways. For example, the AI assistant 102 may be configured to generate one or more queries to confirm understanding of the issue. Additionally, or alternatively, the AI assistant 102 may be configured to generate a recommendation including instructions to resolve the issue. Additionally, or alternatively, the AI assistant may be configured to generate data representing a support ticket describing the issue. Additionally, or alternatively, the AI assistant may be configured to execute instructions configured to resolve the issue.

In some examples, the AI assistant 102 may be configured to ask the user to confirm its understanding of what has happened until the AI assistant 102 has aligned with what the user has experienced. For example, the AI assistant 102 may ask the user to confirm that they were having an issue with “www.someresource.com” at a first time (e.g., 12:00 PM). In such an example, the user may correct the AI assistant 102 and indicate that the user was having the issue with “www. resource. com” at the first time, and the AI assistant 102 may ask the user to confirm the understanding of the issue any number of times prior to proceeding.

As previously described, the AI assistant 102 may use generative AI text generation to recommend next steps to the user. In some examples, the AI assistant 102 may determine that there is not enough information in the event journal to provide a recommendation to the user. In examples where the AI assistant 102 determines that there is not enough information, the AI assistant 102 may be configured to provide instructions to the user regarding how to enable additional logging. In some examples, the AI assistant 102 may be integrated with software on the endpoint device 104 (e.g., the access client 122) and the AI assistant 102 may be configured to automatically enable verbose logging in that software it is integrated with. Additionally, or alternatively, the AI assistant 102 may be configured to automatically trigger diagnostic probes, such as, for example, traceroute, to the resource in question to collect additional data about the issue. In any event, while the AI assistant 102 is gathering more information (e.g., enabling verbose logging, triggering probes, and/or instructing the user to enable additional logging), the AI assistant 102 may be configured to preserve the context of the user's query regarding the issue in the chat session while the user reproduces the issue with the additional logging enabled.

Once the AI assistant 102 has identified enough information in the event journal to generate a recommendation for the user, the AI assistant 102 may generate utilize generative AI text generation to recommend next steps to resolve the issue based on a subset of events identified in the event journal that are relevant to the issue. In some examples, the AI assistant 102 may output the recommendations in the form of text data, audio data, and/or any other form of data that represents natural language communication. Additionally, or alternatively, any number of recommendations may be generated by the AI assistant 102 and/or output in any order. The AI assistant 102 may be configured to generate additional recommendations based on responses from the user with respect to prior recommendations generated by the AI assistant 102.

In some examples, the AI assistant 102 may determine that the issue is user remediable. For example, the issue may be related to updating software (e.g., updating a network access software), which is an action that may be performed by the user and/or within the permissions of the user. The AI assistant 102 may then generate the recommendations to instruct the user on how to resolve the issue that is user remediable. For example, the AI assistant 102 may generate recommendations for the user including step-by-step instructions to update the software. Additionally, or alternatively, the issue may be policy related (e.g., access denied due to lack of permission), which may be out of the user's control. As such, the AI assistant 102 may be configured to generate recommendation(s) for the user including an explanation that the resource is unable to be accessed because the user's network policy (e.g., an enterprise related policy) does not allow the user to access the resource.

Additionally, or alternatively, the issue may require intervention by an IT administrator associated with the endpoint device 104 (e.g., an IT administrator of an enterprise associated with the endpoint device 104). In some examples, the AI assistant 102 may be configured to generate and/or file an IT support ticket on behalf of the user. For example, the AI assistant 102 may be configured to generate an IT support ticket having a title and a summary relevant to the issue based on the conversation the AI assistant 102 had with the user. In some examples, the AI assistant 102 may be configured to attach a raw transcript of the conversation with the user to the IT support ticket. Additionally, or alternatively, the AI assistant 102 may be configured to attach any relevant events from the journal and/or any other artifacts of its analysis of the issue. Additionally, or alternatively, the AI assistant 102 may be configured to highlight the time of occurrence of the issue and/or any other anomalous events on the IT support ticket. Additionally, or alternatively, the AI assistant 102 may be configured to include any network access policy related details in the IT support ticket.

As described herein, the AI assistant 102 may be configured to process network access policies to determine if a user is configured to access the resource the user is having the issue with. For example, the AI assistant 102 may be configured to leverage virtual private network (VPN) routing tables and/or zero trust access steering rules indicated by network access policies to determine whether a given user is configured to access a given resource.

At “6,” the AI assistant 102 may be supplemented with an additional mechanism to execute instructions configured to resolve an issue that may be known, commonly occurring, and/or previously resolved. For example, the IT administrator may define fingerprints of common issues that users may encounter along with instructions on how to remediate said issue. The IT administrator may store the fingerprints in a centralized location that is accessible by various AI assistants executing on various endpoint devices remote from one another. That is, an AI assistant 102 executing on an endpoint device 104 may look for matching fingerprints in the event journal, and if identified, may obtain the instructions from the centralized database and execute the instructions to resolve the issue. In some examples, the fingerprints may be defined using a domain specific language (DSL). Additionally, or alternatively, a centralized AI assistant may be configured to monitor operation of additional AI assistants executing locally on remote endpoint devices, and the centralized AI assistant may be configured to learn new issues that are easily remediable and may generate new fingerprints with instructions to resolve these new issues.

FIG. 3A illustrates a diagram 300 of example user interface(s) 116 that may be displayed in association with the AI assistant 102, as described herein. For example, the user interface(s) 116 may include an access client 302. In some examples, the access client 302 may correspond to the access client 122, as described with respect to FIGS. 1 and 2. The access client 302 may be configured to establish a connection between the endpoint device 104 and a resource, such as, for example, the resource(s) 114 as described with respect to FIG. 1. For example, the access client 302 may be configured to establish a VPN connection. In some examples, the access to the VPN client may be denied. The user may select the details button 304 to invoke the AI assistant 102. With the AI assistant 102 invoked on the user interface 116, the user may converse with the AI assistant 102 via received chats 306(1)-(N) and/or sent chats 308(1)-(N), where N may be any integer greater than 1. The user may continue sending sent chats 308 until the received chats 306 are aligned with the issue the user is experiencing. As illustrated in FIG. 3A, the user may not have permission to access the selected VPN client. For example, the AI assistant 102 may leverage a network access policy to determine that the user does not have access to the selected VPN, and the AI assistant may relay this information to the user via the received chats 306. If the issue is unable to be resolved, the AI assistant 102 may be configured to submit a support ticket on behalf of the user using the received chats 306 and/or the sent chats 308 to build the ticket, as described herein.

FIG. 3B illustrates a diagram 310 of another example user interface(s) 116 that may be displayed in association with the AI assistant 102, as described herein. For example, the user interface(s) 116 may include a browser 312. In some examples, the browser 312 may be configured to allow the endpoint device 104 to access a resource, such as, for example, the resource(s) 114 as described with respect to FIG. 1. For example, the user may leverage the browser to access a resource “www.resource.com” (e.g., a public resource). As illustrated in FIG. 3B, the browser may fail to load the requested resource, and the user may invoke the AI assistant 102 to help resolve the issue with loading the resource. With the AI assistant 102 invoked on the user interface 116, the user may converse with the AI assistant 102 via received chats 306(1)-(N) and/or sent chats 308(1)-(N), where N may be any integer greater than 1. The user may continue sending sent chats 308 until the received chats 306 are aligned with the issue the user is experiencing. As illustrated in FIG. 3B, the endpoint device 104 may not have a functioning internet connection 314. The AI assistant 102 may leverage the log data output by the endpoint device 104 in the event journal to determine the issue. For example, the event journal may include events indicative of a hardware failure (e.g., a wireless network card failure), and the AI assistant 102 may relay this information to the user via received chats 306. Additionally, or alternatively, the event journal may include events indicative of the user disconnecting from a wireless network, and the AI assistant 102 may relay this information to the user with steps to resolve the issue via the received chats 306. If the issue is unable to be resolved, the AI assistant 102 may be configured to submit a support ticket on behalf of the user using the received chats 306 and/or the sent chats 308 to build the ticket, as described herein.

FIG. 3C illustrates a diagram 320 of another example user interface(s) 116 that may be displayed in association with the AI assistant 102, as described herein. For example, the user interface(s) 116 may include a browser 312. In some examples, the browser 312 may be configured to allow the endpoint device 104 to access a resource, such as, for example, the resource(s) 114 as described with respect to FIG. 1. For example, the user may leverage the browser to access a resource “www.privateresource.com” (e.g., a private resource such as an enterprise resource). As illustrated in FIG. 3C, the browser may fail to load the requested resource, and the user may invoke the AI assistant 102 to help resolve the issue with loading the resource. With the AI assistant 102 invoked on the user interface 116, the user may converse with the AI assistant 102 via received chats 306(1)-(N) and/or sent chats 308(1)-(N), where N may be any integer greater than 1. The user may continue sending sent chats 308 until the received chats 306 are aligned with the issue the user is experiencing. Unlike FIG. 3B, the endpoint device 104 has a functioning internet connection. However, the AI assistant 102 may leverage the log data output by the endpoint device 104 in the event journal to determine the issue. Additionally, or alternatively, the AI assistant 102 may leverage network access policies and/or other configuration data from software on the endpoint device (e.g., the browser 322 and/or the access client 302, as described with respect to FIG. 3A. For example, the event journal may include events indicative of issues with an access client utilized to access the private resource targeted by the browser 322, and the AI assistant 102 may relay this information to the user with steps to resolve the issue via the received chats 306. If the issue is unable to be resolved, the AI assistant 102 may be configured to submit a support ticket on behalf of the user using the received chats 306 and/or the sent chats 308 to build the ticket, as described herein.

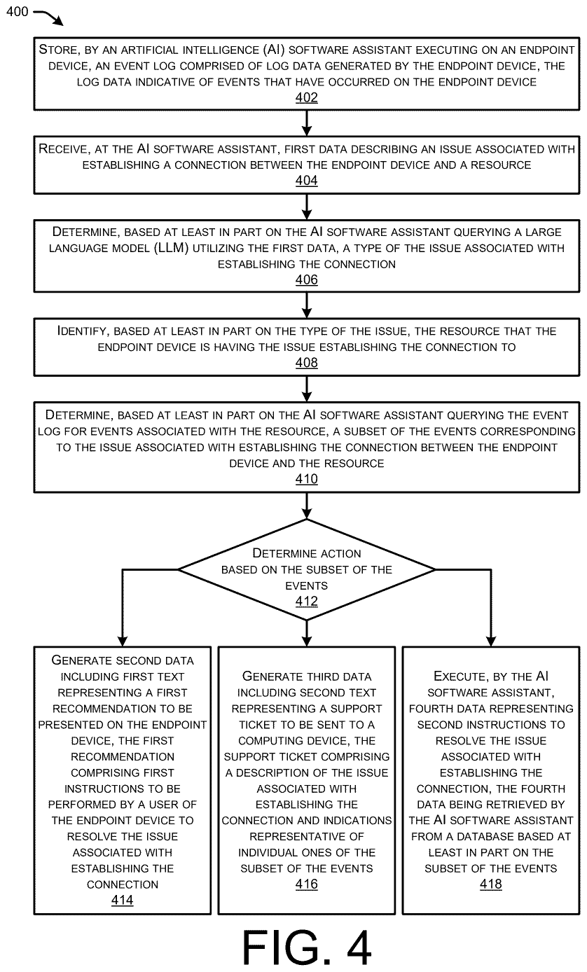

FIG. 4 illustrates a flow diagram of an example method 400 for invoking an AI assistant to resolve an issue associated with establishing a connection between the endpoint device and a resource according to the techniques described herein. In some examples, the endpoint device, the resource, and/or the AI assistant may correspond to the endpoint device 104, the resource 114, and/or the AI assistant 102, as described with respect to FIG. 1.

At 402, the method 400 may include storing, by an artificial intelligence (AI) software assistant executing on an endpoint device, an event log comprised of log data generated by the endpoint device. In some examples, the log data may be indicative of events that have occurred on the endpoint device. Additionally, or alternatively, the event log may correspond to the event journal 120.

At 404, the method 400 may include receiving, at the AI software assistant, first data describing an issue associated with establishing a connection between the endpoint device and a resource. In some examples, the first data may comprise text data, audio data, and/or any other form of data representing natural language.

At 406, the method 400 may include determining a type of the issue associated with establishing the connection. In some examples, determining the type of the issue may be based at least in part on the AI software assistant querying a large language model (LLM) utilizing the first data. For example, the AI assistant may leverage the LLM to better understand the issue that the user is describing.

At 408, the method 400 may include identifying the resource that the endpoint device is having the issue establishing the connection to. In some examples, identifying the resource that the endpoint is having the issue establishing the connection to may be based at least in part on the type of the issue. For example, the type of issue may indicate which resource the endpoint device is having the issue with.

At 410, the method 400 may include determining a subset of the events corresponding to the issue associated with establishing the connection between the endpoint device and the resource. In some examples, determining the subset of the events corresponding to the issue may be based at least in part on the AI software assistant querying the event log for events associated with the resource. For example, the AI assistant may identify certain events in the event log that correspond to the issue and compile these events as the subset of events.

At 412, the method 400 may include determining an action based on the subset of events. In examples where the AI assistant determines that the issue is user remediable, the method 400 may proceed to operation 414. Additionally, or alternatively, in examples where the AI assistant determines that the issue is not user remediable, the method 400 may proceed to operation 416. Additionally, or alternatively, in examples where the AI assistant determines the issue is resolvable without user intervention, the method 400 may proceed to operation 418.

At 414, the method 400 may include generating second data including first text representing a first recommendation to be presented on the endpoint device. In some examples, the first recommendation may comprise first instructions to be performed by a user of the endpoint device to resolve the issue associated with establishing the connection.

At 416, the method 400 may include generating third data including second text representing a support ticket to be sent to a computing device. In some examples, the support ticket may comprise a description of the issue associated with establishing the connection and/or indications representative of individual ones of the subset of the events.

At 418, the method 400 may include executing, by the AI software assistant, fourth data representing second instructions to resolve the issue associated with establishing the connection. In some examples, the fourth data may be retrieved by the AI software assistant from a database based at least in part on the subset of the events. Additionally, or alternatively, the database may correspond to the instruction database 124, as described with respect to FIG. 1.

In some examples, identifying the resource that the endpoint is having the issue establishing the connection to may be based at least in part on querying the LLM based at least in part on at least one of the type of the issue or the first data.

In some examples, the database may be configured as a centralized database that is accessible by the AI software assistant and/or one or more additional AI software assistants executing one or more additional endpoint devices.

Additionally, or alternatively, the method 400 may include causing the endpoint device to display an indication of the resource that the endpoint device is having the issue establishing the connection to. Additionally, or alternatively, the method 400 may include receiving user input indicating at least one of a confirmation of the resource or a rejection of the resource. Additionally, or alternatively, the method 400 may include determining the subset of the events based at least in part on the confirmation of the resource as indicated by the user input. Additionally, or alternatively, the method 400 may include querying the LLM for another resource that the endpoint device is having the issue establishing the connection to based at least in part on the user input indicating the rejection.

Additionally, or alternatively, the method 400 may include generating, based at least in part on the subset of the events, fourth data including third text representing the description of the issue. In some examples, the fourth data causing the endpoint device to display the third text and receive user input. Additionally, or alternatively, the method 400 may include receiving fifth data representing the user input. In some examples, the user input may indicate at least one of a confirmation of the description of the issue or an additional description of the issue. Additionally, or alternatively, the method 400 may include based at least in part on the fifth data, at least one of determining that the description of the issue is complete, determining, based at least in part on the AI software assistant querying the event log using the additional description, a second subset of events corresponding to the issue, and/or generating sixth data including fourth text representing a second recommendation to be presented on the endpoint device. In some examples, the second recommendation comprising second instructions to be performed by the user to resolve the issue.

Additionally, or alternatively, the method 400 may include determining, based at least in part on the subset of the events, that information represented by the subset of the events does not satisfy a threshold amount of information to generate the first recommendation.

Additionally, or alternatively, the method 400 may include Additionally, or alternatively, the method 400 may include based at least in part on determining that the information represented by the subset of the events does not satisfy the threshold amount of information, at least one of generating fourth data including third text representing a request for the user of the endpoint device to provide additional information associated with the issue, generating fifth data including fourth text representing second instructions, to be performed by the user, to enable the endpoint device to generate additional log data for storage in the event log, and/or generating sixth data including fifth text representing third instructions, to be performed by the user, to enable client software, that is executing on the endpoint device and configured establish the connection between the endpoint device and the resource, to generate verbose log data for storage in the event log. Additionally, or alternatively, the method 400 may include determining the subset of the events corresponding to the issue based at least in part on at least one of the additional information, the additional log data, or the verbose log data. In some examples, the additional log data and the verbose log data are generated based at least in part on the user reproducing the issue associated with establishing the connection between the endpoint device and the resource.

Additionally, or alternatively, the method 400 may include identifying a policy associated with client software that is executing on the endpoint device and configured to establish the connection between the endpoint device and the resource. In some examples, the policy may correspond to the user and indicate that the user is one of allowed to access the resource or blocked from accessing the resource. Additionally, or alternatively, the method 400 may include generating the second data including the first text representing the first recommendation based at least in part on the policy. Additionally, or alternatively, the method 400 may include generating the third data including the second text representing the support ticket based at least in part on the policy. In some examples, the support ticket may further comprise an indication that the user is blocked from accessing the resource.

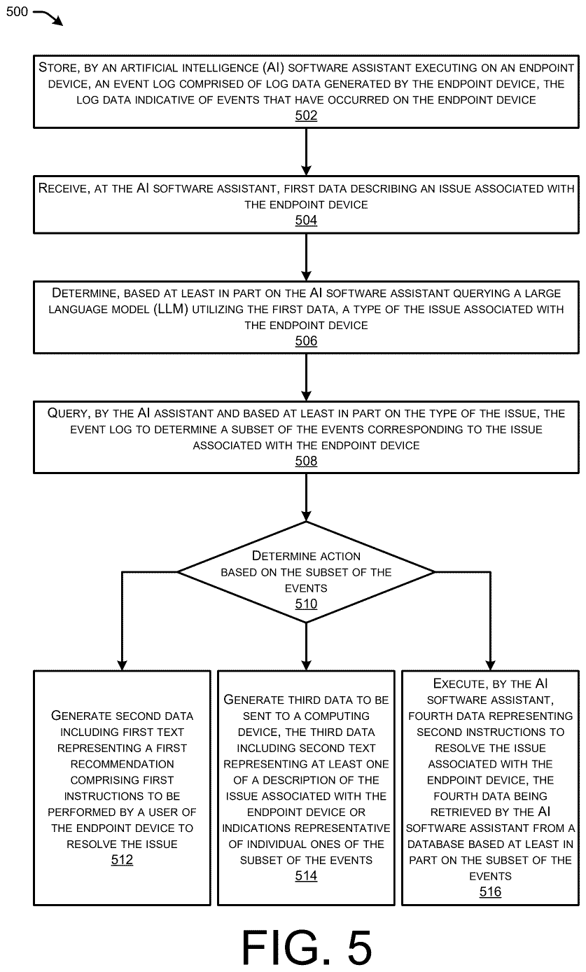

FIG. 5 illustrates a flow diagram of another example method 500 for invoking an AI assistant to resolve an issue associated with the endpoint device according to the techniques described herein. In some examples, the endpoint device and/or the AI assistant may correspond to the endpoint device 104 and/or the AI assistant 102, as described with respect to FIG. 1.

At 502, the method 500 may include storing, by an artificial intelligence (AI) software assistant executing on an endpoint device, an event log comprised of log data generated by the endpoint device. In some examples, the log data may be indicative of events that have occurred on the endpoint device. Additionally, or alternatively, the event log may correspond to the event journal 120.

At 504, the method 500 may include receiving, at the AI software assistant, first data describing an issue associated with the endpoint device. In some examples, the first data may comprise text data, audio data, and/or any other form of data representing natural language.

At 506, the method 500 may include determining a type of the issue associated with the endpoint device. In some examples, determining the type of the issue associated with the endpoint device may be based at least in part on the AI software assistant querying a large language model (LLM) utilizing the first data. For example, the AI assistant may leverage the LLM to better understand the issue that the user is describing.

At 508, the method 500 may include querying, by the AI assistant and based at least in part on the type of the issue, the event log to determine a subset of the events corresponding to the issue associated with the endpoint device. For example, the AI assistant may identify certain events in the event log that correspond to the issue and compile these events as the subset of events.

At 510, the method 500 may include determining an action based on the subset of events. In examples where the AI assistant determines that the issue is user remediable, the method 500 may proceed to operation 512. Additionally, or alternatively, in examples where the AI assistant determines that the issue is not user remediable, the method 500 may proceed to operation 514. Additionally, or alternatively, in examples where the AI assistant determines the issue is resolvable without user intervention, the method 500 may proceed to operation 516.

At 512, the method 500 may include generating second data including first text representing a first recommendation comprising first instructions to be performed by a user of the endpoint device to resolve the issue.

At 514, the method 500 may include generating third data to be sent to a computing device. In some examples, the third data may include second text representing at least one of a description of the issue associated with the endpoint device and/or indications representative of individual ones of the subset of the events.

At 516, the method 500 may include executing, by the AI software assistant, fourth data representing second instructions to resolve the issue associated with the endpoint device. In some examples, the fourth data being retrieved by the AI software assistant from a database based at least in part on the subset of the events.

In some examples, the issue may be associated with at least one of a hardware component of the endpoint device and/or a software component of the hardware device. Additionally, or alternatively, the method 500 may include identifying, based at least in part on querying the LLM utilizing the first data, the software component and/or the hardware component associated with the issue. In some examples, the query to determine the subset of the events may be further based at least in part on identifying the software component and/or the hardware component associated with the issue.

Additionally, or alternatively, the method 500 may include causing the endpoint device to display an indication of the software component or the hardware component associated with the issue. Additionally, or alternatively, the method 500 may include receiving user input indicating at least one of a confirmation of the software component or the hardware component associated with the issue or a rejection of the software component or the hardware component associated with the issue. Additionally, or alternatively, the method 500 may include determining the subset of the events based at least in part on the confirmation of the software component and/or the hardware component associated with the issue. Additionally, or alternatively, the method 500 may include querying the LLM for another software component or another hardware component associated with the issue based at least in part on the rejection.

In some examples, the database may be configured as a centralized database that is accessible by the AI software assistant and one or more additional AI software assistants executing one or more additional endpoint devices.

Additionally, or alternatively, the method 500 may include generating, based at least in part on the subset of the events, fourth data including third text representing the description of the issue. In some examples, the fourth data may cause the endpoint device to display the third text and receive user input. Additionally, or alternatively, the method 500 may include receiving fifth data representing the user input. In some examples, the user input may indicate at least one of a confirmation of the description of the issue or an additional description of the issue. Additionally, or alternatively, the method 500 may include Additionally, or alternatively, the method 500 may include based at least in part on the fifth data, at least one of determining that the description of the issue is complete, determining, based at least in part on the AI software assistant querying the event log using the additional description, a second subset of events corresponding to the issue, and/or generating sixth data including fourth text representing a second recommendation to be presented on the endpoint device. In some examples, the second recommendation may comprise second instructions to be performed by the user to resolve the issue.

Additionally, or alternatively, the method 500 may include determining, based at least in part on the subset of the events, that information represented by the subset of the events does not satisfy a threshold amount of information to generate the first recommendation. Additionally, or alternatively, the method 500 may include based at least in part on determining that the information represented by the subset of the events does not satisfy the threshold amount of information, at least one of generating fourth data including third text representing a request for the user of the endpoint device to provide additional information associated with the issue, generating fifth data including fourth text representing second instructions, to be performed by the user, to enable the endpoint device to generate additional log data for storage in the event log, and/or generating sixth data including fifth text representing third instructions, to be performed by the user, to enable client software, that is executing on the endpoint device, to generate verbose log data for storage in the event log. Additionally, or alternatively, the method 500 may include determining the subset of the events corresponding to the issue based at least in part on at least one of the additional information, the additional log data, and/or the verbose log data. In some examples, wherein the additional log data and/or the verbose log data may be generated based at least in part on the user reproducing the issue associated with the endpoint device.

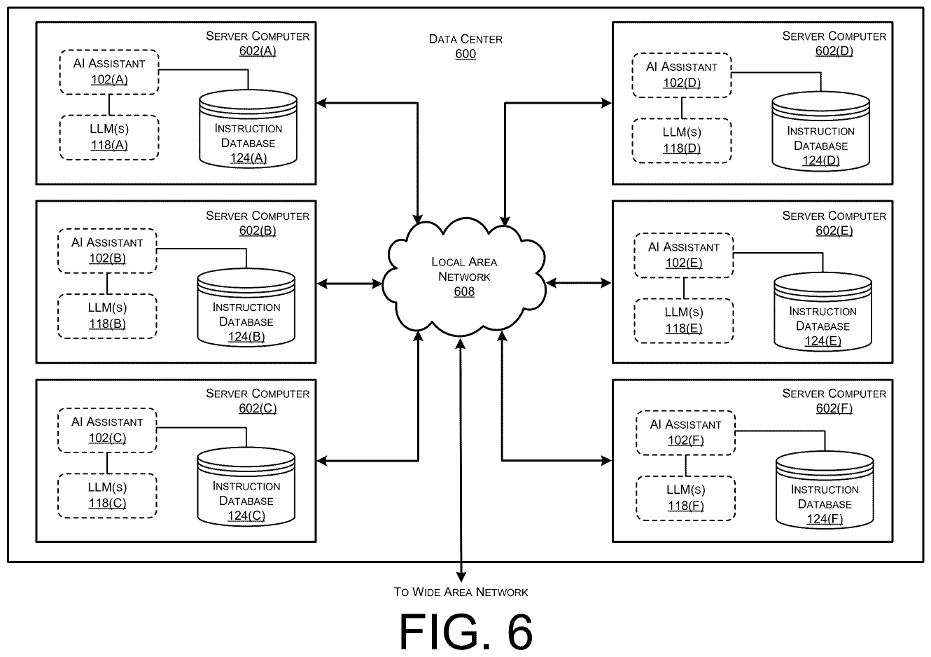

FIG. 6 is a computing system diagram illustrating a configuration for a data center 600 that can be utilized to implement aspects of the technologies disclosed herein. The example data center 600 shown in FIG. 6 includes several server computers 602A-602E (which might be referred to herein singularly as “a server computer” or in the plural as “the server computers”) for providing computing resources. In some examples, the server computer(s) 602 may include, or correspond to, servers associated with the computing resource network 106 described herein with respect to FIG. 1.

The server computers 602 can be standard tower, rack-mount, or blade server computers configured appropriately for providing the computing resources described herein. As mentioned above, the computing resources provided by the computing resource network 106 can be data processing resources such as VM instances or hardware computing systems, database clusters, computing clusters, storage clusters, data storage resources, database resources, networking resources, and others. Some of the server computers 602 can also be configured to execute a resource manager capable of instantiating and/or managing the computing resources. In the case of VM instances, for example, the resource manager can be a hypervisor or another type of program configured to enable the execution of multiple VM instances on a single server computer 602. Server computers 602 in the data center 600 can also be configured to provide network services and other types of services.

In the example data center 600 shown in FIG. 6, an appropriate LAN 608 is also utilized to interconnect the server computers 602A-602E. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602E in each data center 600, and, potentially, between computing resources in each of the server computers 602. It should be appreciated that the configuration of the data center 600 described with reference to FIG. 6 is merely illustrative and that other implementations can be utilized.

In some examples, the server computers 602 may each execute an AI assistant 102, one or more LLM(s) 118, and/or an instruction database 124.

In some instances, the computing resource network 106, may provide computing resources, like application containers, VM instances, and storage, on a permanent or an as-needed basis. Among other types of functionality, the computing resources provided by the computing resource network 106, may be utilized to implement the various services described above. The computing resources provided by the computing resource network 106, can include various types of computing resources, such as data processing resources like application containers and VM instances, data storage resources, networking resources, data communication resources, network services, and the like.

Each type of computing resource provided by the computing resource network 106, can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The computing resource network 106, can also be configured to provide other types of computing resources not mentioned specifically herein.

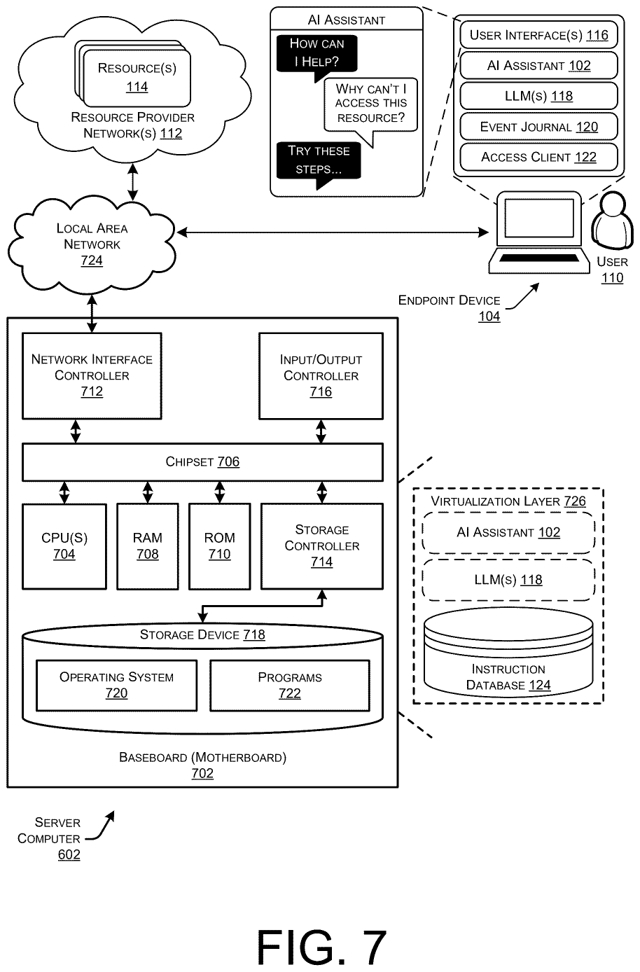

The computing resources provided by the computing resource network 106, may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 shows an example computer architecture for a server computer (or computing device/network routing device) 602 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The server computer 602 may, in some examples, correspond to a physical server associated with the computing resource network 106 described herein with respect to FIG. 1.

The server computer 602 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the server computer 602.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the server computer 602. The chipset 706 can further provide an interface to a computer-readable storage medium such as a read-only memory (“ROM”) 710 or non-volatile RAM (“NVRAM”) for storing basic routines that help to startup the server computer 602 and to transfer information between the various components and devices. The ROM 710 or NVRAM can also store other software components necessary for the operation of the server computer 602 in accordance with the configurations described herein.

The server computer 602 can operate in a networked environment using logical connections to remote server computers and computer systems through a network, such as the network 724 (or 608). The chipset 706 can include functionality for providing network connectivity through a NIC 712, such as a gigabit Ethernet adapter. The NIC 712 is capable of connecting the server computer 602 to other computing devices over the network 724. It should be appreciated that multiple NICs 712 can be present in the server computer 602, connecting the computer to other types of networks and remote computer systems.

The server computer 602 can be connected to a storage device 718 that provides non-volatile storage for the server computer 602. The storage device 718 can store an operating system 720, programs 722, and data, which have been described in greater detail herein. The storage device 718 can be connected to the server computer 602 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 602 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the server computer 602 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 602 can further read information from the storage device 718 by detecting the physical states or characteristics of one or more particular locations within the physical storage units.

In addition to the mass storage device 718 described above, the server computer 602 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 602. In some examples, the operations performed by the computing resource network 106, and/or any components included therein, may be supported by one or more devices similar to server computer 602. Stated otherwise, some or all of the operations performed by the computing resource network 106, and/or any components included therein, may be performed by one or more server computers 602 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the server computer 602. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the server computer 602.

In one embodiment, the storage device 718 or other computer-readable storage media is encoded with computer-executable instructions which, when loaded into the server computer 602, transform the computer from a general-purpose computing system into a special-purpose computer capable of implementing the embodiments described herein. These computer-executable instructions transform the server computer 602 by specifying how the CPUs 704 transition between states, as described above. According to one embodiment, the server computer 602 has access to computer-readable storage media storing computer-executable instructions which, when executed by the server computer 602, perform the various processes/methods described above with regard to FIGS. 2, 4, and 5. The server computer 602 can also include computer-readable storage media having instructions stored thereupon for performing any of the other computer-implemented operations described herein.

The server computer 602 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the server computer 602 might not include all of the components shown in FIG. 7, can include other components that are not explicitly shown in FIG. 7, or might utilize an architecture completely different than that shown in FIG. 7.

The server computer 602 may support a virtualization layer 726, such as one or more components associated with the computing resource network 106. For example, the computing resource network 106 may comprise an instruction database 124, an AI assistant 102, and/or one or more LLM(s) 118. The instruction database 124 may be accessible by the AI assistant 102 executing in the virtualization layer 726 of the server computer and/or by one or more remote AI assistant(s) 102 executing on an endpoint device 104. The instruction database 124 may store one or more sets of instructions configured to be executed on an endpoint device and resolve a given issue. Additionally, or alternatively, the LLM(s) may be leveraged by the AI assistant 102 executing in the virtualization layer 726 of the server computer and/or by one or more remote AI assistant(s) 102 executing on an endpoint device 104 according to the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
storing, by an artificial intelligence (AI) software assistant executing on an endpoint device, an event log comprised of log data generated by the endpoint device, the log data indicative of events that have occurred on the endpoint device;
receiving, at the AI software assistant, first data describing an issue associated with establishing a connection between the endpoint device and a resource;
determining, based at least in part on the AI software assistant querying a large language model (LLM) utilizing the first data, a type of the issue associated with establishing the connection;
identifying, based at least in part on the type of the issue, the resource that the endpoint device is having the issue establishing the connection to;
determining, based at least in part on the AI software assistant querying the event log for events associated with the resource, a subset of the events corresponding to the issue associated with establishing the connection between the endpoint device and the resource; and
based at least in part on the subset of the events, at least one of:
generating second data including first text representing a first recommendation to be presented on the endpoint device, the first recommendation comprising first instructions to be performed by a user of the endpoint device to resolve the issue associated with establishing the connection;
generating third data including second text representing a support ticket to be sent to a computing device, the support ticket comprising a description of the issue associated with establishing the connection and indications representative of individual ones of the subset of the events; or
executing, by the AI software assistant, fourth data representing second instructions to resolve the issue associated with establishing the connection, the fourth data being retrieved by the AI software assistant from a database based at least in part on the subset of the events.

2. The method of claim 1, wherein identifying the resource that the endpoint device is having the issue establishing the connection to is based at least in part on querying the LLM based at least in part on at least one of the type of the issue or the first data.

3. The method of claim 1, wherein the database is configured as a centralized database that is accessible by the AI software assistant and one or more additional AI software assistants executing one or more additional endpoint devices.

4. The method of claim 1, further comprising:
causing the endpoint device to display an indication of the resource that the endpoint device is having the issue establishing the connection to;
receiving user input indicating at least one of a confirmation of the resource or a rejection of the resource; and
based at least in part on the user input, at least one of:
determining the subset of the events based at least in part on the confirmation of the resource; or
querying the LLM for another resource that the endpoint device is having the issue establishing the connection to.

5. The method of claim 1, further comprising:
generating, based at least in part on the subset of the events, fourth data including third text representing the description of the issue, the fourth data causing the endpoint device to display the third text and receive user input;
receiving fifth data representing the user input, the user input indicating at least one of a confirmation of the description of the issue or an additional description of the issue; and
based at least in part on the fifth data, at least one of:
determining that the description of the issue is complete;
determining, based at least in part on the AI software assistant querying the event log using the additional description, a second subset of events corresponding to the issue; or
generating sixth data including fourth text representing a second recommendation to be presented on the endpoint device, the second recommendation comprising second instructions to be performed by the user to resolve the issue.

6. The method of claim 1, further comprising:
determining, based at least in part on the subset of the events, that information represented by the subset of the events does not satisfy a threshold amount of information to generate the first recommendation;
based at least in part on determining that the information represented by the subset of the events does not satisfy the threshold amount of information, at least one of:
generating fourth data including third text representing a request for the user of the endpoint device to provide additional information associated with the issue;
generating fifth data including fourth text representing second instructions, to be performed by the user, to enable the endpoint device to generate additional log data for storage in the event log; or
generating sixth data including fifth text representing third instructions, to be performed by the user, to enable client software, that is executing on the endpoint device and configured establish the connection between the endpoint device and the resource, to generate verbose log data for storage in the event log; and
determining the subset of the events corresponding to the issue based at least in part on at least one of the additional information, the additional log data, or the verbose log data, wherein the additional log data and the verbose log data are generated based at least in part on the user reproducing the issue associated with establishing the connection between the endpoint device and the resource.

7. The method of claim 1, further comprising:
identifying a policy associated with client software that is executing on the endpoint device and configured to establish the connection between the endpoint device and the resource, the policy corresponding to the user and indicating that the user is one of:
allowed to access the resource; or
blocked from accessing the resource; and
at least one of:
generating the second data including the first text representing the first recommendation based at least in part on the policy; or
generating the third data including the second text representing the support ticket based at least in part on the policy, the support ticket further comprising an indication that the user is blocked from accessing the resource.

8. A system comprising:
one or more processors; and
one or more non-transitory computer-readable media storing instructions that, when executed by the one or more processors, cause the one or more processors to perform operations comprising:
storing, by an artificial intelligence (AI) software assistant executing on an endpoint device, an event log comprised of log data generated by the endpoint device, the log data indicative of events that have occurred on the endpoint device;
receiving, at the AI software assistant, first data describing an issue associated with the endpoint device;
determining, based at least in part on the AI software assistant querying a large language model (LLM) utilizing the first data, a type of the issue associated with the endpoint device;
querying, by the AI software assistant and based at least in part on the type of the issue, the event log to determine a subset of the events corresponding to the issue associated with the endpoint device; and
based at least in part on the subset of the events, at least one of:
generating second data including first text representing a first recommendation comprising first instructions to be performed by a user of the endpoint device to resolve the issue;
generating third data to be sent to a computing device, the third data including second text representing at least one of a description of the issue associated with the endpoint device or indications representative of individual ones of the subset of the events; or
executing, by the AI software assistant, fourth data representing second instructions to resolve the issue associated with the endpoint device, the fourth data being retrieved by the AI software assistant from a database based at least in part on the subset of the events.

9. The system of claim 8, wherein the issue is associated with at least one of a hardware component of the endpoint device or a software component of the endpoint device, and the operations further comprising identifying, based at least in part on querying the LLM utilizing the first data, the software component or the hardware component associated with the issue, wherein the query to determine the subset of the events is further based at least in part on identifying the software component or the hardware component associated with the issue.

10. The system of claim 9, the operations further comprising:
causing the endpoint device to display an indication of the software component or the hardware component associated with the issue;
receiving user input indicating at least one of a confirmation of the software component or the hardware component associated with the issue or a rejection of the software component or the hardware component associated with the issue; and
based at least in part on the user input, at least one of:
determining the subset of the events based at least in part on the confirmation of the software component or the hardware component associated with the issue; or
querying the LLM for another software component or another hardware component associated with the issue.

11. The system of claim 8, wherein the database is configured as a centralized database that is accessible by the AI software assistant and one or more additional AI software assistants executing one or more additional endpoint devices.

12. The system of claim 8, the operations further comprising:
generating, based at least in part on the subset of the events, fourth data including third text representing the description of the issue, the fourth data causing the endpoint device to display the third text and receive user input;
receiving fifth data representing the user input, the user input indicating at least one of a confirmation of the description of the issue or an additional description of the issue; and
based at least in part on the fifth data, at least one of:
determining that the description of the issue is complete;
determining, based at least in part on the AI software assistant querying the event log using the additional description, a second subset of events corresponding to the issue; or
generating sixth data including fourth text representing a second recommendation to be presented on the endpoint device, the second recommendation comprising second instructions to be performed by the user to resolve the issue.

13. The system of claim 8, the operations further comprising:
determining, based at least in part on the subset of the events, that information represented by the subset of the events does not satisfy a threshold amount of information to generate the first recommendation;
based at least in part on determining that the information represented by the subset of the events does not satisfy the threshold amount of information, at least one of:
generating fourth data including third text representing a request for the user of the endpoint device to provide additional information associated with the issue;
generating fifth data including fourth text representing second instructions, to be performed by the user, to enable the endpoint device to generate additional log data for storage in the event log; or
generating sixth data including fifth text representing third instructions, to be performed by the user, to enable client software, that is executing on the endpoint device, to generate verbose log data for storage in the event log; and
determining the subset of the events corresponding to the issue based at least in part on at least one of the additional information, the additional log data, or the verbose log data, wherein the additional log data and the verbose log data are generated based at least in part on the user reproducing the issue associated with the endpoint device.

14. One or more non-transitory computer-readable media storing instructions that, when executed by one or more processors, cause the one or more processors to perform operations comprising:
storing, by an artificial intelligence (AI) software assistant executing on an endpoint device, an event log comprised of log data generated by the endpoint device, the log data indicative of events that have occurred on the endpoint device;
receiving, at the AI software assistant, first data describing an issue associated with the endpoint device;
determining, based at least in part on the AI software assistant querying a large language model (LLM) utilizing the first data, a type of the issue associated with the endpoint device;
querying, by the AI software assistant and based at least in part on the type of the issue, the event log to determine a subset of the events corresponding to the issue associated with the endpoint device; and
based at least in part on the subset of the events, at least one of:
generating second data including first text representing a first recommendation comprising first instructions to be performed by a user of the endpoint device to resolve the issue;
generating third data to be sent to a computing device, the third data including second text representing at least one of a description of the issue associated with the endpoint device or indications representative of individual ones of the subset of the events; or
executing, by the AI software assistant, fourth data representing second instructions to resolve the issue associated with the endpoint device, the fourth data being retrieved by the AI software assistant from a database based at least in part on the subset of the events.

15. The one or more non-transitory computer-readable media of claim 14, wherein the issue is associated with at least one of a hardware component of the endpoint device or a software component of the endpoint device, and the operations further comprising identifying, based at least in part on querying the LLM utilizing the first data, the software component or the hardware component associated with the issue, wherein the query to determine the subset of the events is further based at least in part on identifying the software component or the hardware component associated with the issue.

16. The one or more non-transitory computer-readable media of claim 15, the operations further comprising:
causing the endpoint device to display an indication of the software component or the hardware component associated with the issue;
receiving user input indicating at least one of a confirmation of the software component or the hardware component associated with the issue or a rejection of the software component or the hardware component associated with the issue; and
based at least in part on the user input, at least one of:
determining the subset of the events based at least in part on the confirmation of the software component or the hardware component associated with the issue; or
querying the LLM for another software component or another hardware component associated with the issue.

17. The one or more non-transitory computer-readable media of claim 14, wherein the database is configured as a centralized database that is accessible by the AI software assistant and one or more additional AI software assistants executing one or more additional endpoint devices.

18. The one or more non-transitory computer-readable media of claim 14, the operations further comprising:
generating, based at least in part on the subset of the events, fourth data including third text representing the description of the issue, the fourth data causing the endpoint device to display the third text and receive user input;
receiving fifth data representing the user input, the user input indicating at least one of a confirmation of the description of the issue or an additional description of the issue; and
based at least in part on the fifth data, at least one of:
determining that the description of the issue is complete;
determining, based at least in part on the AI software assistant querying the event log using the additional description, a second subset of events corresponding to the issue; or
generating sixth data including fourth text representing a second recommendation to be presented on the endpoint device, the second recommendation comprising second instructions to be performed by the user to resolve the issue.

19. The one or more non-transitory computer-readable media of claim 14, the operations further comprising:
determining, based at least in part on the subset of the events, that information represented by the subset of the events does not satisfy a threshold amount of information to generate the first recommendation;
based at least in part on determining that the information represented by the subset of the events does not satisfy the threshold amount of information, at least one of:
generating fourth data including third text representing a request for the user of the endpoint device to provide additional information associated with the issue;
generating fifth data including fourth text representing second instructions, to be performed by the user, to enable the endpoint device to generate additional log data for storage in the event log; or
generating sixth data including fifth text representing third instructions, to be performed by the user, to enable client software, that is executing on the endpoint device, to generate verbose log data for storage in the event log; and
determining the subset of the events corresponding to the issue based at least in part on at least one of the additional information, the additional log data, or the verbose log data, wherein the additional log data and the verbose log data are generated based at least in part on the user reproducing the issue associated with the endpoint device.

20. The one or more non-transitory computer-readable media of claim 14, wherein the issue comprises at least one of:
a first issue associated with establishing a first connection, wherein first connection is configured as an internet connection;
a second issue associated with establishing a second connection between the endpoint device and a resource; or
a third issue associated with a quality of at least one of the first connection or the second connection.
